(19) United States
(12) Patent Application Publication
(10) Pub. No.: US 2009/0282855 A1
(43) Pub. Date: Nov. 19, 2009

(54) UNDER COUNTER ICE MAKING MACHINE

(75) Inventors: Greg MAPLES, Senoia, GA (US); Kristopher T. Miller, Newman, GA (US)

Correspondence Address: ARENT FOX LLP, 1050 CONNECTICUT AVENUE, N.W., SUITE 400, WASHINGTON, DC, 20036, US

(73) Assignee: Hoshizaki America, Inc., Peachtree City, GA (US)

(21) Appl. No.: 12/122,275

(22) Filed: May 16, 2008

(51) Int. Cl. F25C 5/18; F25C 5/02; F25D 25/00; F16K 31/18; G05D 15/00

(52) U.S. Cl. 62/344; 62/320; 62/381; 137/409; 236/67

(57) ABSTRACT

An under the counter ice making machine having a top opposite a bottom, a front opposite a back, and two sides that collectively define an interior. A casing defines exterior-most surfaces of the ice machine. An ice bin is mounted inside the casing of the device, wherein a compressor is mounted inside the ice machine and below the ice bin and an evaporator assembly is mounted inside the casing and above the ice bin. A gear motor is operably connected to the evaporator assembly and is also mounted above the ice bin.

### BACKGROUND OF THE PRESENT INVENTION

1. Field of the Invention

The present invention relates to an ice making machine, and in particular, to a consumer or non-industrial ice making machine. The present invention also relates to an ice making machine that can be used in a home or office, and more particularly to an ice making machine that is placed under a countertop.

2. Description of Related Art

Generally, ice making machines (hereinafter referred to simply as “ice machines”) that are to be located under a countertop have especially compact designs suitable for their particular application. Apart from their size, these ice machines function similarly to larger industrial ice machines and have similarly functioning components, which include various types of evaporators, accumulators, valves, compressors, pumps, thermostats and the like.

The compressor forces refrigerant through a condenser tube which releases the condensed gas into the evaporator where the refrigerant gas expands and evaporates. The evaporation process cools a metal ice holder over which water is poured, leading to ice build-up. Many designs include triggering a bypass valve shunting warm gas from the compressor into a wide tube that bypasses the condenser. The warm gas is cycled back to the evaporator where the warm gas heats the ice holder. The process loosens the ice so that the ice may be mechanically directed into a collection bin.

There are many different mechanisms for removing the ice cubes from the tray, including levers and other mechanical devices. In some designs, such as that of some of the variations of the present invention, an auger mechanism is used to convey the ice formed in the evaporator into a cutting mechanism that creates the ice cubes. In any case, once the ice cubes are formed, the cubes generally flow down a ramp to a thermally isolated collection bin. The bins basically store the ice cubes on the front of the device and are accessed through at lease one door attached to the housing.

Under countertop ice machines generally have components that need constant maintenance, such as the evaporators, drains and or compressors. Bearings in such components need frequent replacement, seals can break or weaken, and any of the many moving parts may fail due to fatigue. Further, routine or constant maintenance necessitates the periodic cleaning and servicing of the components (i.e., pipes, pumps and valves) involved in the water circuit. Therefore, providing easy access to the most frequently serviced components of under countertop ice machine is crucial for replacement or maintenance of these devices.

Generally, the architecture of under countertop ice machines, especially the positioning of the ice bin and evaporator assemblies relative to the major components in the water and refrigeration circuits, presents a problem in servicing. Evaporators are often difficult to access as they are typically hidden behind structural components. The removal of evaporators often requires the removal or dismantling of much of the ice machine, including most of the housing. Very few under countertop ice machines allow the extraction of major components, such as the evaporator, without completely removing the ice machine from an operating environment. Further, many designs are such that access to the very components needing regular servicing, maintenance and cleaning is either difficult, restricted or both. Accordingly, there is a need in the art for an under countertop ice machine with a design that makes servicing easier.

In addition, the rather complex control circuits employed by many models for regulating the production of ice and to monitor the major components in the process add an additional level of complexity to servicing the ice machine. For example, these often include control boards governing solenoid valves for supplying warm gas to the evaporator for ice cube removal, as described above. The complex control circuits and circuit boards also govern other processes, such as various fail-safe or shut off mechanisms protecting components of the system from damage that might occur when operated in a low water condition caused by freeze-ups or clogs.

Generally, adding a printed circuit board to such a system increases the difficulty and expense of servicing the ice machine. Further, using a control board to operate various components needed to execute the ice making process often requires using components that are not particularly robust. Thus, there is a need for an ice machine having a more simple design that accomplishes various necessary control features (such as shutting off relatively fragile components in the event of low water, free-up or clogging conditions) without the added complexity of a central control ice machine using a printed circuit board. It would be especially advantageous to have diagnostic and fail-safe routines to be performed by more robust, mechanical components rather than through the use of complicated circuitry and/or algorithms.

### SUMMARY OF THE INVENTION

Accordingly, embodiments of the present invention are directed to an under counter or countertop ice machine with improved serviceability that substantially obviates one or more of the above-described problems resulting from the limitations and disadvantages of the related art.

An aspect of the present invention is to provide an under counter ice machine with a design allowing improved access to serviceable components.

Another aspect of the present invention is to provide of an under counter ice machine with a design and components that are more robust, require less servicing, and are less complicated.

Yet another aspect of the present invention is to provide components for an under counter ice machine that are more amenable to servicing.

Additional aspects, features and advantages of the present invention will be set forth in the description which follows, and in part will be apparent from the following description, or may be readily learned by practice of the present invention without undue experimentation. The aspects, objectives and other advantages of the present invention will be realized and attained by the structure particularly pointed out in the written description and claims hereof as well as the appended drawings.

To achieve these and other aspects, objectives and advantages, the present invention, as embodied and broadly described herein, provides for an under counter ice machine with improved serviceability that includes an interior, a top side opposite a bottom side, a front side opposite a back side, two opposing and parallel left and right sides that comprise a casing having exterior surfaces; a door on the front side of the ice machine mounted to the casing for providing access to the interior of the ice machine; an ice bin mounted inside the casing of the ice machine, wherein the ice bin can be accessed using the door; a compressor mounted inside the casing of the ice machine; and an evaporator assembly inside the casing of the ice machine. The evaporator assembly is mounted to be at least partially surrounded by the exterior surfaces of the casing and such that the evaporator can be removed from the ice machine and replaced without also removing the casing therefrom.

In another aspect, the under counter ice machine of the present invention may include a gear motor mounted in the interior; a suction line temperature safety mounted near a suction line to the compressor; a compressor relay electrically coupled to the suction line temperature safety for shutting off operation of the compressor according to a reading taken by the suction line temperature safety, wherein the electrical coupling of the compressor relay and the suction line temperature safety is accomplished without a printed circuit board; and a gear motor protect relay, the gear motor protect relay being electrically coupled to the suction line temperature safety for shutting off the operation of the gear motor according to a reading taken by the suction line temperature safety, wherein the electrical coupling of the gear motor protect relay and the suction line temperature safety is accomplished without a printed circuit board.

In yet another aspect, the under counter ice machine of the present invention may include a thermostat thermally coupled to the ice bin; a compressor relay electrically coupled to the thermostat for shutting off the operation of the compressor according to a reading taken by the thermostat, wherein the electrical coupling of the compressor relay and the thermostat is accomplished without a printed circuit board; and a gear motor protect relay electrically coupled to the thermostat for shutting off the operation of the gear motor according to a reading taken by the thermostat, wherein the electrical coupling of the gear motor protect relay and the thermostat is accomplished without a printed circuit board.

It is to be understood that both the foregoing general description and the following detailed description are exemplary and explanatory and are intended to provide further explanation of embodiments of the present invention as claimed.

Additional advantages and novel features relating to the present invention will be set forth in part in the description that follows, and in part will become more apparent to those skilled in the art upon examination of the following or upon learning by practice other aspects of the present invention.

### BRIEF DESCRIPTION OF THE DRAWINGS

The accompanying drawings, which are included to provide a further understanding of embodiments of the present invention and are incorporated in and constitute a part of this specification, illustrate embodiments of the present invention and together with the description serve to explain the principles of embodiments of the present invention.

In the drawings:

FIG. 1A is a perspective view of an ice making machine according to an embodiment of the present invention;

FIG. 1B is a top view of the present invention shown in FIG. 1A, showing the relation of a door to an ice bin;

FIG. 2A is a schematic diagram illustrating water and refrigeration circuits included within the present invention;

FIG. 2B is a front view of a partially disassembled, open-door internal layout of the present invention shown in FIGS. 1-2A;

FIG. 2C is a front view of an assembled open-door internal layout of the present invention shown in FIG. 2B;

FIG. 2D is an exploded rear view of the internal layout of the present invention shown in FIG. 2B;

FIG. 3A-3C shows steps for servicing an evaporator assembly and a gear motor of an exemplary ice making device in accordance with aspects of the present invention;

FIG. 4 is an exploded view of the evaporator assembly including the gear motor;

FIG. 5 is a perspective view of the upper portion of a drain mechanism;

FIG. 6 is an overview of the drain mechanism;

FIG. 7 is a schematic diagram illustrating the wiring of the present invention;

FIG. 8 is a schematic diagram illustrating the electrical connections during the ice making process;

FIG. 9 is a schematic diagram illustrating the electrical connections as a thermostat opens to shut down the gear motor, fan motor and compressor;

FIG. 10 is a schematic diagram illustrating the electrical connections as a suction temperature safety opens to shut down the gear motor, fan motor and compressor; and

FIG. 11 illustrates exemplary suction temperature safety cut-out/cut-in temperatures.

### DETAILED DESCRIPTION OF PREFERRED EMBODIMENTS

Aspects of the present invention and implementations thereof are not limited to the specific components or assembly procedures disclosed herein. Many additional components and assembly procedures known in the art consistent with the intended under counter ice machine with improved serviceability, ice making or refrigeration devices, ice making or refrigeration procedures and assembly and maintenance procedures for ice making or refrigeration devices will become apparent for manufacture and/or use with the particular variations and implementations discussed herein.

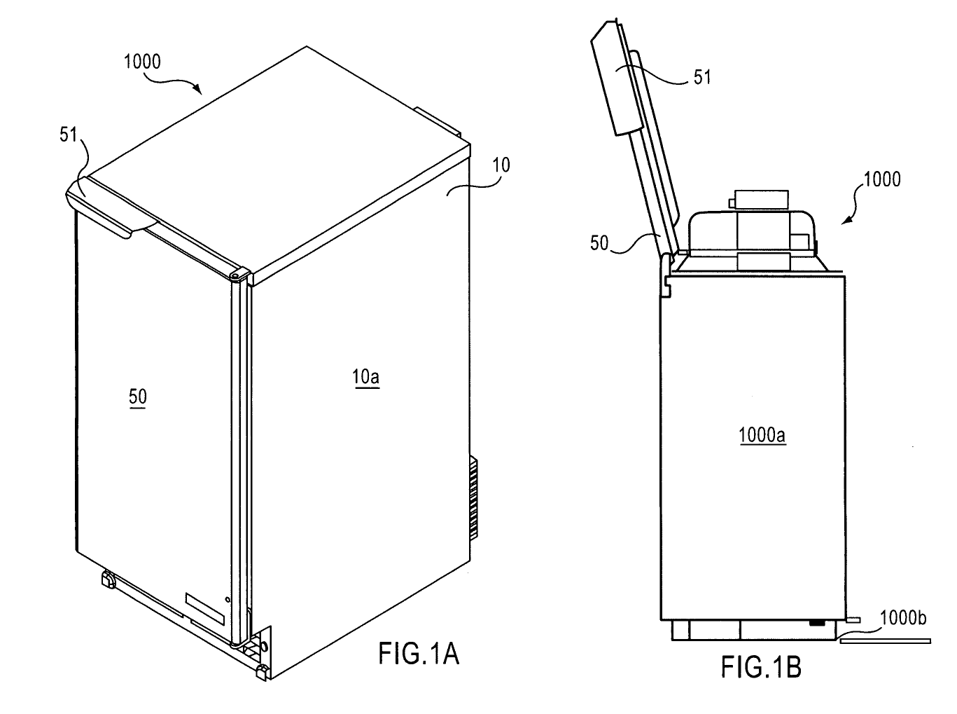

Referring to FIG. 1A, the ice making machine (alternatively described herein as “ice machine”) or ice machine 1000 according to an embodiment of the present invention has at least one door 50 attached to a front thereof. Although one door is shown, it is within the scope of the present invention to have multiple doors in any number of suitable configurations including, but not limited to, multiple front doors as well as side, rear or top doors. The ice machine 1000 has a rectangular shape, as shown in FIG. 1A. Alternatively, it is within the scope of the present invention to have any other suitable geometric shape, including, but not limited to, a rounded shape, and shapes with either more or fewer sides than those shown. For example, it may be advantageous to have a non-rectangularly shaped ice machine 1000 in order to better accommodate certain under counter or other spaces that are similarly non-rectangularly shaped.

As also shown in FIG. 1A, the ice machine 1000 has a casing 10 that defines at least one exterior-most surface, such as a side surface 10a. As shown in FIG. 1A, the casing 10 encompasses an interior of the ice machine 1000, including the internal components (not shown) thereof. The casing 10 may comprise a monolithic piece, or may comprise a plurality of pieces that may be bolted, glued or fastened together by one of a number of other methods. The casing 10 may also comprise brushed steel or other type of steel, aluminum plating, another metal or one of a number of other materials such as plastic.

Referring to FIG. 1B, the door 50 is operably coupled to the ice machine 1000 via a hinge 50b, such that swinging the door 50 open provides access to ice stored in the ice bin 90. Although a side swiveling door is opened by pulling a handle 51 shown in FIGS. 1A and 1B, it is within the scope of the present invention the door 50 to open in a number of different suitable manners, including, but not limited to, a top-swiveling manner, a side sliding manner, or rolling and folding manner. FIG. 1B also shows a rear portion 1000b of the ice machine 100 positioned opposite the door 50. It is also within the scope of the present invention to locate the door 50 on a top side 1000a of the ice machine.

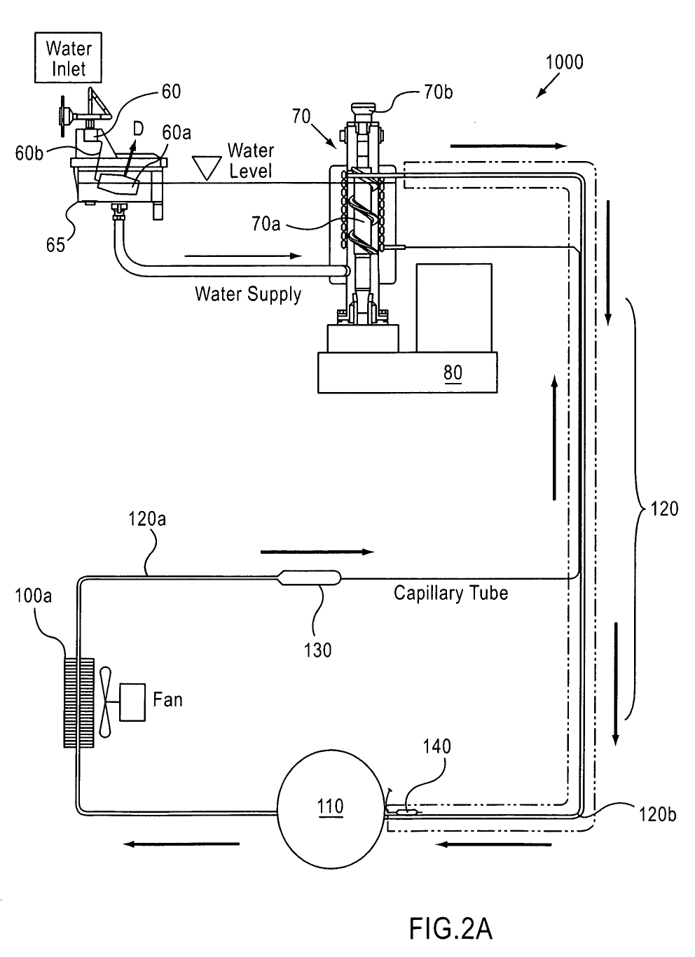

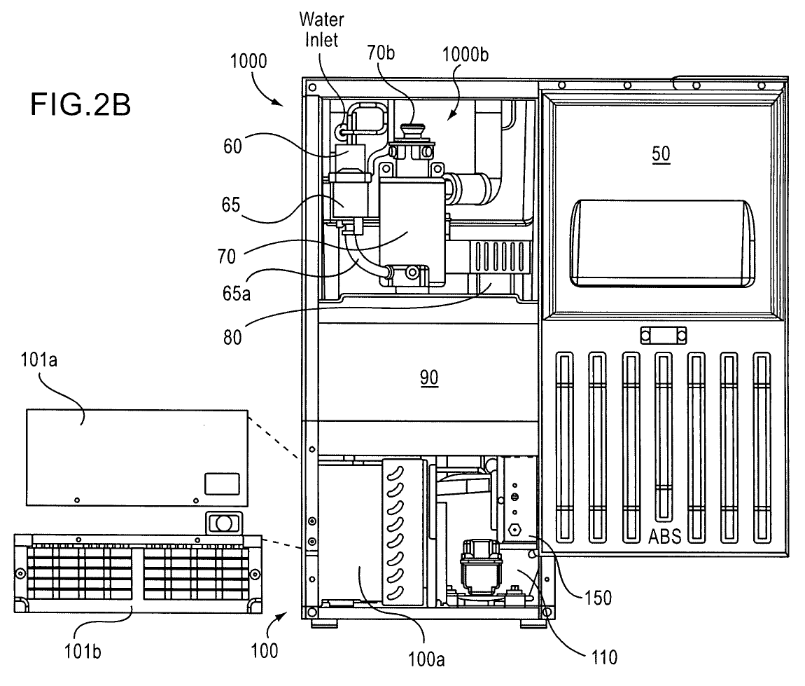

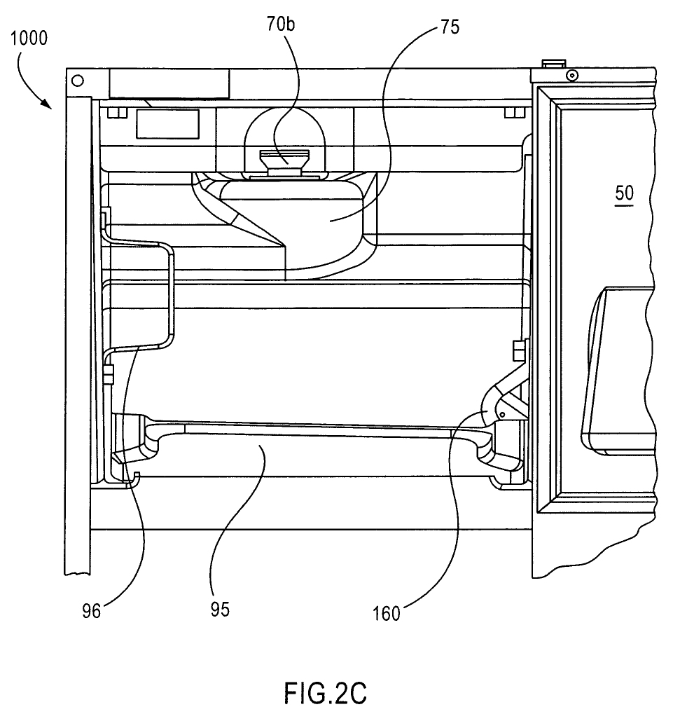

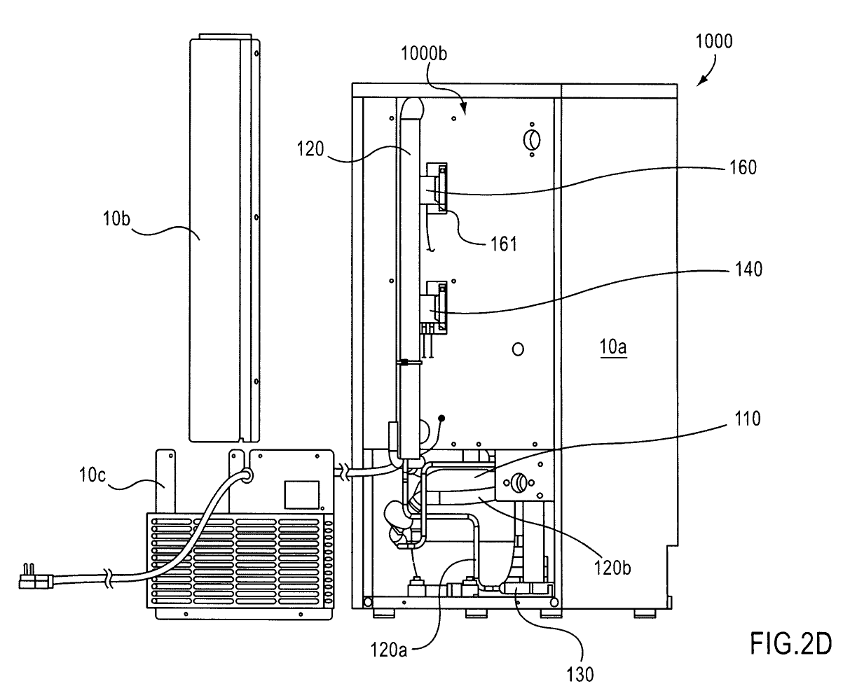

FIG. 2A is a schematic diagram of water and refrigeration circuits included in the ice machine 1000. Referring to FIG. 2A, water enters the ice machine 1000 from a water inlet. The water inlet may be connected to a conventional spigot or other water delivery system used in domestic or professional applications, or the water inlet may be connected to one of a number of other sources of water including a tank or water storage trough. Water entering the ice machine 1000 through the water inlet is collected in a water reservoir 65 until the water level has reached a pre-determined value or “Water Level,” as shown in FIG. 2A. The “Water Level” may be set by the user or vendor, or it may be pre-determined during assembly of the ice machine. When the water in the reservoir reaches the pre-determined value or “Water Level,” a float-operated water valve 60 determines the condition and mechanically shuts off the flow of water from the water inlet. As shown in FIG. 2A, under normal operation, water flows from the reservoir 65 to an evaporator assembly 70 where the water is frozen into ice. An auger 70a, which is a component of the evaporator assembly 70, is driven by a gear motor 80 and extrudes the ice to a cutter 70b where the ice is cut into cubes, which are then redirected to an ice bin 90.

Refrigerant is provided to the evaporator assembly 70 by a compressor 110 so that the evaporator assembly 70 may freeze the water into ice. The operation of this portion of the device is as follows. The compressor 110 compresses the refrigerant gas and forces the gas into the condenser 100a via conduit or tube 120a. The condenser 100a is cooled by a fan, as shown in FIG. 2A. From the condenser 100a, the refrigerant gas flows through a drier 130 to eliminate excess moisture, and into a capillary tube. The refrigerant gas is then passed through a heat exchanger 120 via tube 120a to the evaporator assembly 70. Inside the evaporator assembly 70, the refrigerant is expanded, causing the water supplied by the water reservoir 65 to freeze. The auger 70a rotates and extrudes the ice to the cutter 70b where the ice is cut into cubes.

Once the refrigerant gas has been expanded in the evaporator assembly 70, the gas is directed from the evaporator assembly 70 via a pipe 120b to the heat exchanger 120. Subsequently, the gas is routed via the pipe 120b back to the compressor 110 to be re-used. Before passing the compressor 100, the refrigerant gas flows by a suction temperature safety 140. The suction temperature safety 140 is in thermal communication with the pipe 120b of the heat exchanger 120 and measures the refrigerant gas passing through the pipe 120b. As will be discussed in further detail below, the suction temperature safety 140 is electrically coupled to various electrical components of the ice machine 100 and shuts off operation of the electrical components upon determination of blockage or a freeze-up condition.

The suction temperature safety 140 may include one of a number of temperature measuring devices, including, but not limited to, a thermocouple. The suction temperature safety 140 may itself include a printed circuit board as well as a digital thermometer. Alternatively, the suction temperature safety 140 may be an analog device, such as a conventional thermometer. The suction temperature safety 140 may have a variety of shapes and configurations, including the lozenge-shaped configuration illustrated in FIG. 2A. The suction temperature safety 140 may be powered by a main power supply supplying power to the ice machine 1000, or independently powered, such as through batteries or an independent connection to a power source. The suction temperature safety 140 may be connected to other elements, such as those containing a printed circuit board, where data obtained by the suction temperature safety 140 may be stored and analyzed for diagnostic purposes. The suction temperature safety 140 may also have additional connections (not shown), including wireless connections, that enable it to be temporarily connected to another device for diagnostic or recording purposes.

Referring to FIG. 2B, the float-operated water valve 60 supplies water from the water inlet to the water reservoir 65, where the water is stored and subsequently routed to the evaporator assembly 70. Returning to FIG. 2A, a floating mechanism 60a is used by the float-operated water valve 60 to shut off the water supplied to the water reservoir 65 from the water inlet. The float-operated water valve 60 may contain any number of mechanical, electromechanical or optical mechanisms for determining the water level (FIG. 2A). As shown in FIG. 2A, in one embodiment, the float-operated water valve 60 deflects or pulls a lever arm 60b according to displacement D of the floating mechanism 60a in response to the water level. Pulling the lever arm 60b opens and shuts the float-operated water valve 60. A mechanical and simple design for the float-operated water valve 60, such as that shown in FIG. 2A, is preferable and can be advantageous in that the valve 60 is generally more robust than more complicated designs and is generally less difficult to service. Other more complicated designs for the water valve, however, are also compatible with variations of the present invention and should be considered within the scope of the invention.

Returning to FIG. 2B, the evaporator assembly 70 and the gear motor 80 are mounted above an ice bin 90. The ice bin 90 fits into a refrigerated or thermally isolated portion of the interior 1000b of the ice machine 1000. The condenser assembly 100, as shown in FIG. 2B, is mounted below the ice bin 90 and next to the compressor 110. The condenser assembly 100, includes a condenser 100a, a fan (FIG. 2A) for cooling the condenser 100a during operation, as well as a mounting (not shown) for securing the condenser 100a to a bottom of the ice machine 1000. Upon assembly of the ice machine 1000, a front panel 101a and a louver 101b are fastened to the housing 10 such that the condenser assembly 100 and the compressor 110 have exposure to sufficient ventilation via the louver 101b.

The ice machine 1000 also includes a power box 150 in which a power supply and any AC/DC conversion circuitry, such as inverters, are located (not shown). Generally, the power box 150 contains relatively simple switches and/or fuses and other relatively simple electronic components. Using simpler components in the power box 150 tends to increase the ease of servicing the ice machine 1000. In some variations, however, the power box 150 may also contain more sophisticated electronic components for switching operation modes of the ice machine 1000.

As shown in FIG. 2C, the interior of the 1000b (FIG. 2B) of the ice machine 1000 is thermally isolated from the ice bin 90 and contents thereof. The evaporator assembly 70 and other portions of the interior 1000b are covered by a spout 75 manufactured from a thermally insulating material, such as a plastic. The spout 75 is generally form-fitted to the evaporator assembly 70, as shown in FIG. 2B. The spout 75 also functions to channel the ice cubes from the cutter 70b to the bin 90 once the ice has been expelled by evaporator assembly 70.

In addition, FIG. 2C shows a slope portion that allows a user to access the ice in the ice bin 90. Generally, the slope portion 95 is a horizontal tray that folds outward automatically as the door 50 opens and folds inward when the door 50 is closed. However, other configurations of the slope portion 95 are also with the scope of the present invention, which include but are not limited to, slope portions that slide outwardly from the interior of the ice bin 95, or other portion of the ice machine 1000, or slope portions that operate via hinges, swivels or other such mechanisms.

FIG. 2C also shows a thermostat 160 mounted to the side of the ice bin 90. The thermostat 160 is in thermal communication with the ice bin 90 for measuring the temperature of the ice bin 90. As will be discussed in detail below, the thermostat 160 is also in electrical communication with various other components, including the gear motor 80 and the compressor 110, and serves to shut off operation of such components when the ice bin 90 is full. The thermostat 160 may include one of a number of temperature measuring devices, including, for example only, a thermocouple. The thermostat 160 may itself include a printed circuit board and a digital thermometer. Alternatively, the thermostat 160 may be an analog device, such as one including a conventional thermometer. The thermostat 160 may have a variety of shapes and configurations, including the rectangular configuration illustrated in FIG. 2C. The thermostat 160 may also be powered by a main power supply supplying power to the ice machine 1000, or it may be independently powered, such as through batteries or a power connection that is independent of the rest of the ice machine 1000. The thermostat 160 may be connected to other elements, such as those containing a printed circuit board where its data may be stored and analyzed for diagnostic purposes. The thermostat 160 may also have additional connections (not shown) that enable the thermostat to be temporarily connected to another device for diagnostic or recording purposes.

FIG. 2D shows the heat exchanger 120 connecting the compressor 110 with the evaporator assembly 70 (FIG. 2B). The tube 120a and pipe 120b are located within the heat exchanger 120. As shown in FIG. 2A, the first pipe 120a transports refrigerant to the evaporator assembly 70 (FIG. 1C) from the condenser 100 (FIG. 1C) after having passed through the drier 130. The drier 130 removes excess water vapor from the refrigerant. The tube 20a also contains a capillary tube (FIG. 2A) for increasing the pressure of the refrigerant. The pipe 120b transports the refrigerant from the evaporator assembly 70 (FIG. 1C) to the compressor 110. The tube 120a and the pipe 120b may be composed of a variety of suitable materials, including copper, steel, other metals and plastic.

The heat exchanger 120 is generally sheathed in insulating material that may comprise, for example only, insulating foam. The heat exchanger 120 is covered by a heat exchanger cover 10b that is part of the casing 10 of the ice machine 1000, as shown in FIG. 2D. The casing 10 also includes a rear panel 10c for covering the compressor assembly 100. In addition, the rear portion 1000b includes a thermostat holder 161 that holds the thermostat 160 used to measure the temperature of the ice bin 90. The operation of the thermostat 160 will be explained below in detail.

FIG. 2D also shows the suction temperature safety 140 being mounted on the rear portion 1000b of the ice machine 1000. The suction temperature safety 140 is in thermal communication with the pipe 120b (as shown in FIG. 2A) for measuring the temperature of the pipe 120b. As will be discussed in detail below, the suction temperature safety 140 is also in electrical communication with various other components, including the gear motor 80 and the compressor 110, and serves to shut off operation of such components in the case of a clog or of ice blockage in the heat exchanger 120 or other parts of the ice machine 1000.

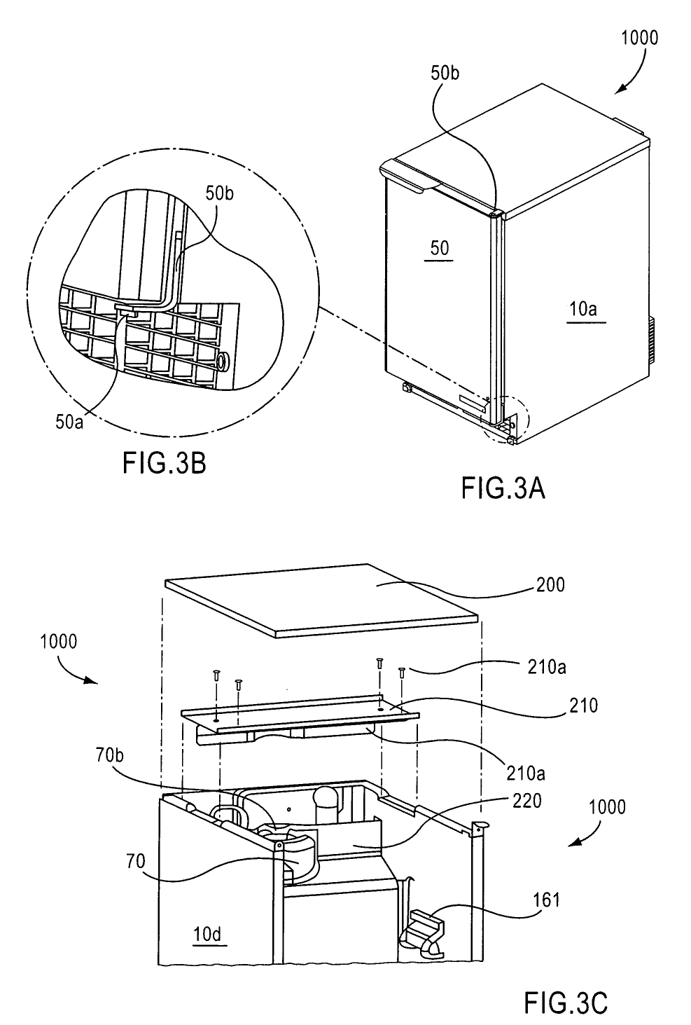

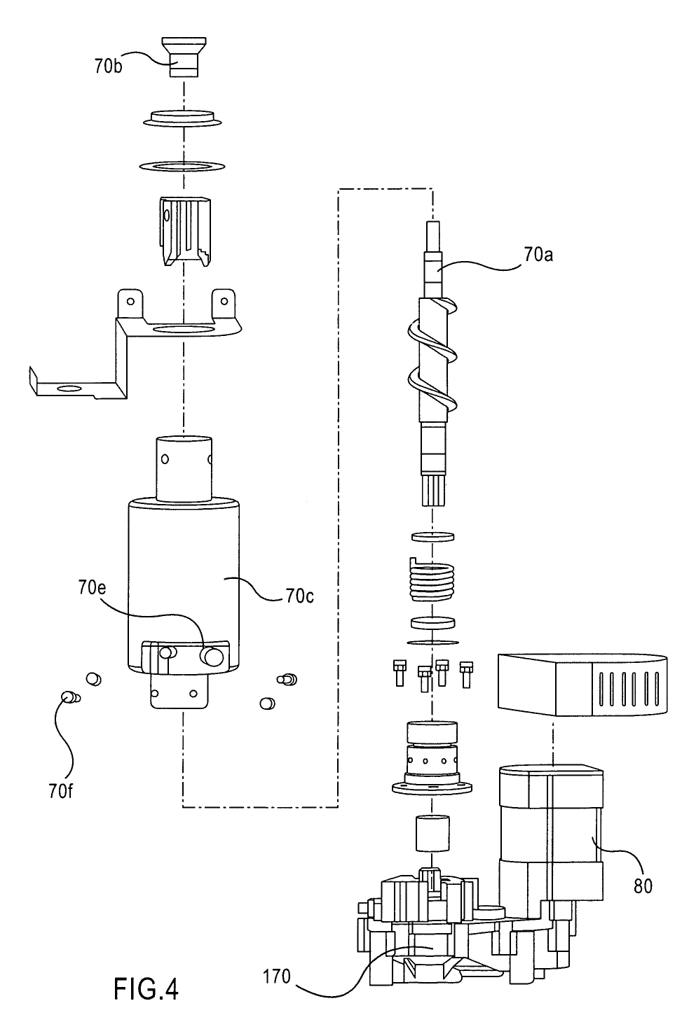

FIG. 3A-3C show steps for servicing the evaporator assembly and the gear motor of an exemplary ice making device in accordance with aspects of the present invention. FIG. 4 is an exploded view of the evaporator assembly including the gear motor. It should be noted that, in servicing either the evaporator assembly 70 or the gear motor 80, the configuration of the ice machine 1000 is such that disassembly of the casing 10 is not required. Rather, the evaporator assembly 70 and the gear motor 80 may be removed from the ice machine 1000 and replaced without extensive disassembly of the ice machine 1000. Servicing and removal of the evaporator assembly 70 and gear motor 80, as well as other components thereof, is substantially simplified over servicing of other ice makers having other and more complicated designs in at least the sense that it requires the removal and replacement of fewer components of the device.

### Removal and Replacement of Evaporator

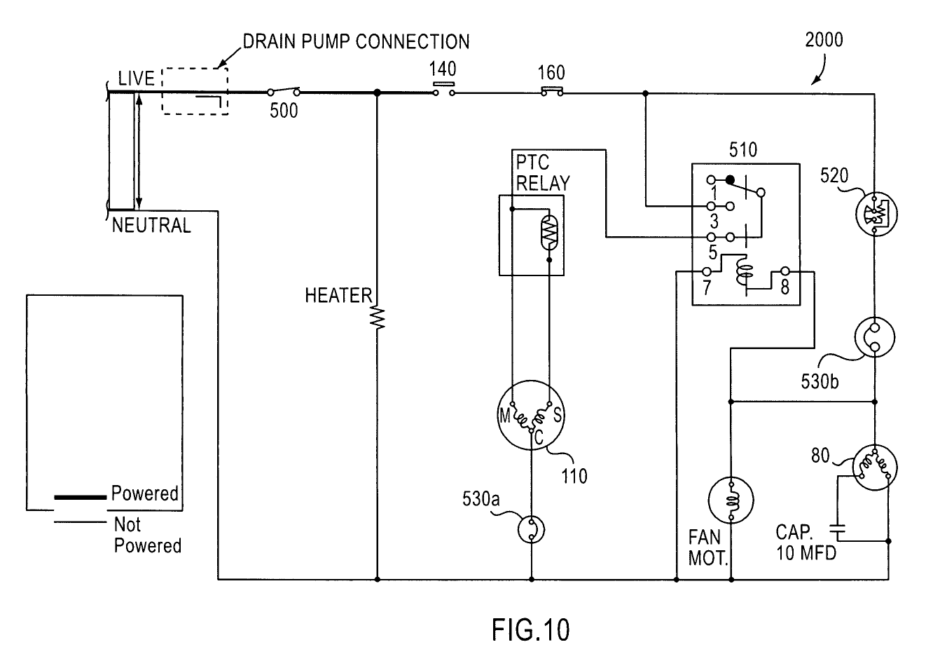

The user may either remove the entire evaporator assembly 70 as one piece, do so in section (i.e., by first removing the auger 70a, and then the evaporator 70c). In either case, the casing 10 and, specifically, the side walls 10a (FIG. 3A) and 10d (FIG. 3C) are left intact.

First, the ice machine 1000 is unplugged and powered down, and the water supply line is shut-off. The door 50 is removed as follows. A hinge stop pin 50a is removed from the hinge 50b. The door 50 is pulled from the hinge 50b and lifted off the ice machine 1000. Next, the top panel 200 is removed after screws (not shown) holding the panel 200 in place are removed. Then, fastening devices 210a, e.g., screws securing the cover bracket 210 are removed and the cover bracket 210 is lifted off the ice machine 1000. The thermostat holder 161 is also removed from the ice machine 1000 once it has been unfastened from the side wall 10d, as shown in FIG. 3C. Then, the spout 75 (FIGS. 2C and 3C) and the water reservoir 65 are removed. The evaporator assembly 70 is then disconnected from the water supply hose 65a (FIG. 2B) at the connection point 70d. The rear panel 10c (FIG. 2D) is removed and the evaporator assembly 70 drained via the drain cap 70e. The evaporator assembly 70 is then disconnected from the tube 120a and the water reservoir 65 removed. Various brackets are removed and the evaporator assembly 70 is subsequently de-mounted by removing the Allen head cap screws 70f that secure the evaporator 70c to a lower housing 170 and lifting up the evaporator assembly 70. Replacing the evaporator assembly 70 is substantially the reverse of the above described operation.

### Removal and Replacement of Gear Motor

The user can either remove the gear motor 80 in one piece or by removing the entire lower housing 170 with the gear motor 80 contained therein. In the latter case, the evaporator assembly 70 must also be removed from the ice machine 1000. As with the removal of the evaporator assembly 70, the casing 10 and, specifically, the side walls 10a (FIG. 3A) and 10d (FIG. 3C) are left intact.

The following is a description of removing the gear motor 80 only. First, the ice machine 1000 is unplugged and powered down, and the water supply line is shut-off and then the door 50 is removed. The door 50 is removed as follows. The hinge stop pin 50a is removed from the hinge 50b and the door 50 is pulled from the hinge 50b and lifted off the ice machine 1000. Next, the top panel 200 is removed after screws (not shown) holding the panel 200 in place are removed. Then, fastening devices 210a, e.g., screws, securing the cover bracket 210 are removed and the cover bracket 210 is lifted off the ice machine 1000 as is the thermostat holder 161 once it has been unfastened from the side wall 10d, as shown in FIG. 3C. Then, the spout 75 (FIG. 3C) and the water reservoir 65 are removed. Various brackets are removed, the evaporator assembly 70 is then lifted up slightly and the gear motor 80 is unbolted from the lower housing 170. The gear motor 70 is subsequently lifted off the lower housing 170. Replacing the gear motor 80 is substantially the reverse of the above described operation.

### Serviceable Drain Mechanism

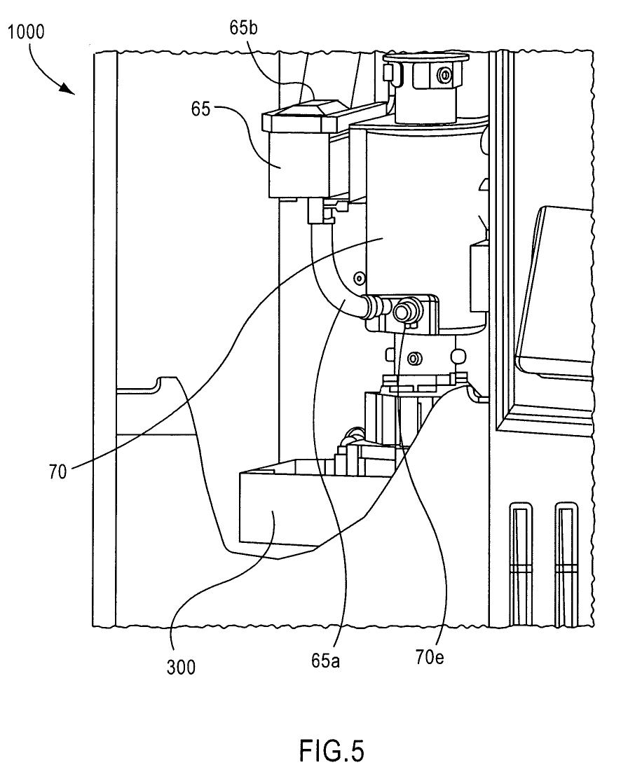

FIG. 5 is a perspective view of an upper portion of a drain mechanism provided within the ice machine 1000. As can be seen in FIG. 5, the drain mechanism includes a drain pan 300, which serves to collect condensate forming on the evaporator assembly 70 during use, and water drained from the evaporator assembly 70 during the replacement procedures described above. In addition, the drain pan 300 collects water from the evaporator 70c during cleaning or maintenance of the ice machine 1000.

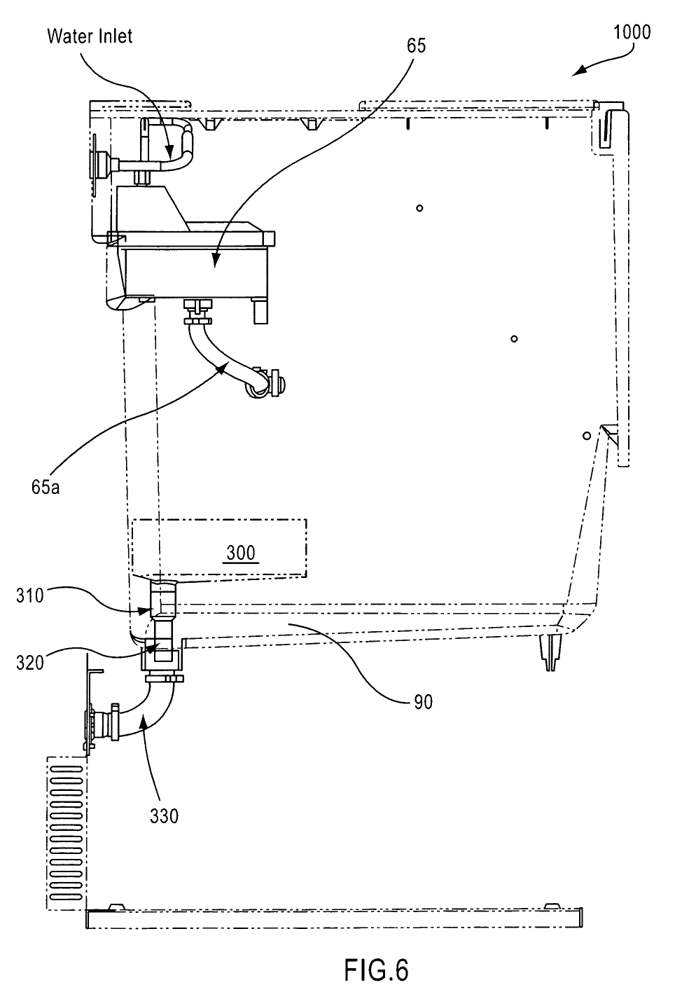

FIG. 6 is an overview of the drain mechanism. As shown in FIG. 6, the drain pan 300 empties into a first receptacle 310 that channels the collected water into an intermediate pipe 320. Simultaneously, water from melting ice in the ice bin 90 collects in a second receptacle. Both the intermediate pie 320 and the second receptacle empty into the main drain pipe 330. In this way, the drain pan 300 and the ice bin 90 share the same drain. Once the excess water from either the drain pan 300 or the ice bin 90 enters the drain pipe 330, the water is expelled from the ice machine 1000 either to a drain connected to a local sewer system, an evaporation tank, or other mechanism for disposing of excess water.

The ice machine 1000 with a centralized drain mechanism, such as that shown in FIG. 6 improves or simplifies servicing in several key ways. First, having a single drain mechanism, as opposed to multiple drain mechanisms for the ice bin 90 and drain pan 300, allows drain clogs to be more easily identified and eliminated. Second, the single drain mechanism minimizes the amount of tubing in the drain system as well as the use of complicated plumbing fixtures, thereby minimizing potential clogs and leaks. Third, cleaning and general maintenance of a single drain system is substantially simpler than for more complicated multi-branching drain systems.

### Electrical Connections and Protective Circuitry

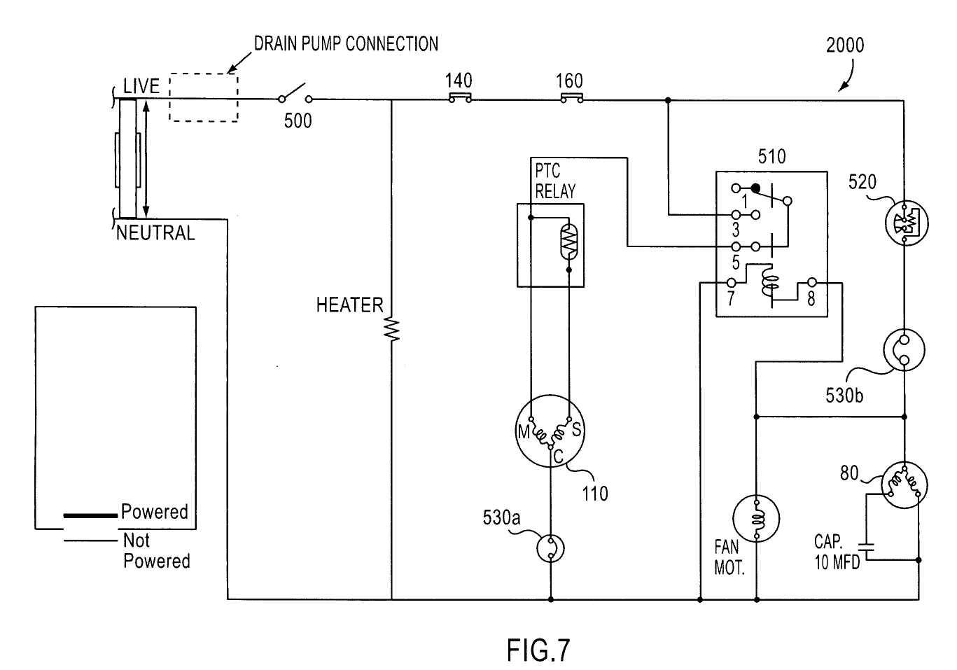

FIG. 7 shows the wiring diagram in accordance with aspects of the present invention. Note that the wiring diagram of FIG. 7 shows a system 2000 that can be used in the variation of the present invention disclosed as ice machine 1000. Note further that the system 2000 is just as applicable to other variations of the present invention as well as other ice making devices not shown or discussed herein. As indicated in the key on the lower left-hand portion of the figure, thicker lines in the wiring diagram indicate powered segments while thinner lines indicate a segment of the wiring diagram that is not powered.

As shown in FIG. 7, the power switch 500 located in the power box 150 (FIG. 2B) controls access to power for the system 2000. FIG. 7 shows an open power switch 500 and, correspondingly, that the system 2000 is in an non-powered state. The system 2000 can contain a HEATER element, as shown in FIG. 7, as well as a PTC relay for shutting down the compressor 110 in the event of a temperature surge. As shown in FIG. 7, the system 2000 can also contain a compressor relay 510, the compressor 110 itself, the gear motor 80, a motor protective fuse 520, two thermal protective fuses 530a and 530b, a fan motor (FAN MOT.) as well as the thermostat 160 and suction temperature safety 140. As further indicated in FIG. 7, the system may also include a connection to a drain pump near the position of the power switch 500. Alternatively, the system 2000 may have additional components and/or lack one or more of the components represented in FIG. 7.

As shown in FIG. 7, both the thermostat 160 and suction temperature safety 140 are shown in the closed state in FIG. 7. When either the thermostat 160 or suction temperature safety 140 are in the open or triggered state, power is cut off to the compressor 110 and the gear motor 80. The process of triggering the thermostat 160 and suction temperature safety 140 will be described in more detail below.

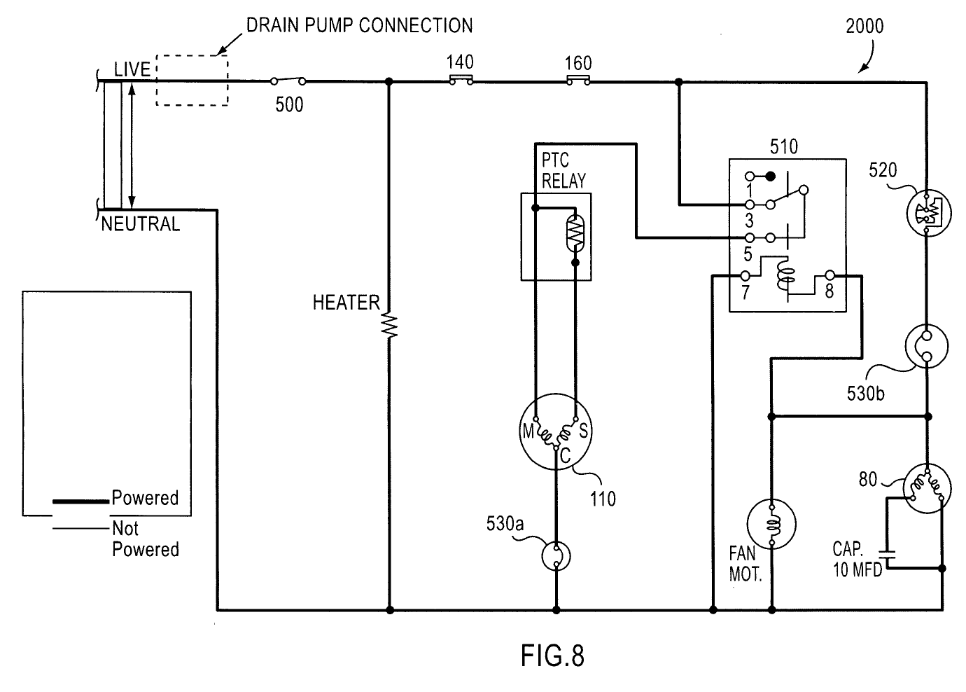

FIG. 8 shows the electrical connections during the ice making process in accordance with aspects of the present invention. In FIG. 8, the power switch 500, the thermostat 160 and the suction temperature safety 140 are all closed. Therefore, FIG. 8 represents a fully powered system 2000. In this condition, the compressor 110 continuously supplies refrigerant to the condenser 100a and ultimately to the evaporator assembly 70, as shown in FIG. 2A. Further, the gear motor 80 continuously turns the auger 70a (FIG. 4) and makes ice.

In the condition shown in FIG. 8, the amount of ice in the ire bin 90 is sufficiently low so that the thermostat 160 reading is below a pre-determined threshold value that opens the thermostat 160 and shuts off power to the compressor 110 and gear motor 80. Further, in the condition shown in FIG. 8, the water and refrigeration circuits of FIG. 2A are functioning normally so that there is no clog or ice blockage and water is continuously being supplied to the system through the water reservoir 65 and the water supply hose 65a (FIG. 2B).

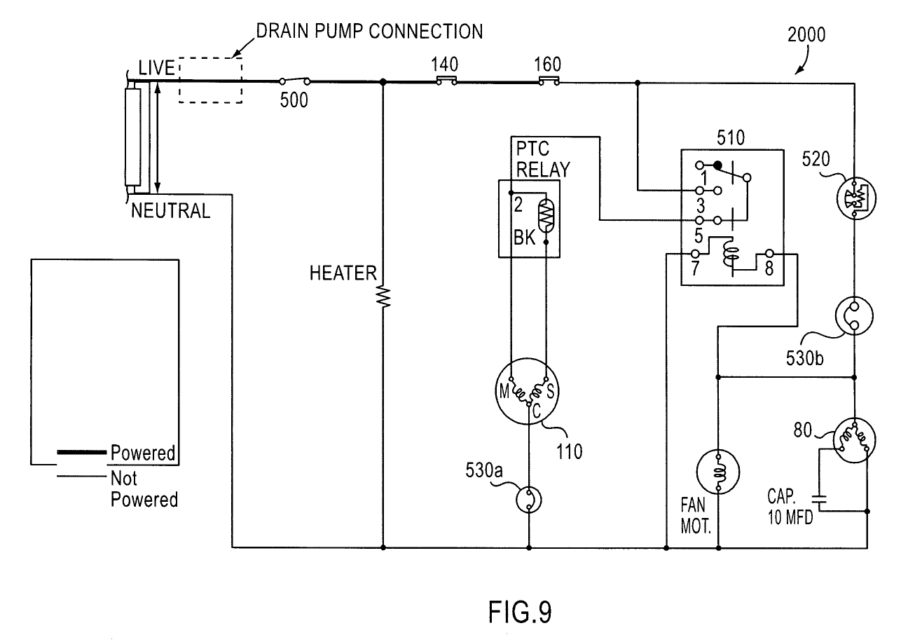

FIG. 9 shows the electrical connections as the thermostat 160 opens to shut down the gear motor, fan motor and compressor of an exemplary ice making device in accordance with aspects of the present invention. As explained above, in this condition the thermostat 160 measures a thermostat cut-out temperature in the ice bin 90 indicating that the ice bin 90 is full. For a given ice bin 90 and a given desired bin fill level, the thermostat cut-out temperature will depend on ambient conditions. Therefore, the thermostat cut-out temperature may need to be re-calibrated for changes ambient conditions if they change dramatically at a given location or for changes in ambient conditions due to displacing system 2000 from an original location. Variations of this invention include thermostats with adjustable cut-out temperatures, and more particularly user adjustable cut-out temperatures. In additional variations of the present invention, the thermostat 160, control ice machine 150 or other portion of the ice machine 1000 includes systems for measuring ambient temperature and pressure for adjusting the thermostat cut-out temperature accordingly.

The desired bin fill level, i.e., exactly how much ice in the ice bin 90 constitutes a “full” state, is set by the thermostat cut-out temperature. This fill level may vary according to user preference. In one example variation of the present Invention, the user measures the temperature of the ice kin 90 under the desired full condition and uses the results of the measurement to set the threshold value of the thermostat 160. In another, the thermostat 160 has a factory pre-set thermostat cut-out temperature that is not user-changeable.

In addition, to the thermostat cut-out temperature for the thermostat 160, as described above, there is also a thermostat cut-in temperature. The thermostat cut-in temperature is the temperature at which the thermostat 160 switches back on power to the compressor 110 and gear motor 80 after the ice bin 90 has been sufficiently emptied. Variations of the present invention also include thermostats 160 with user-changeable thermostat cut-in temperatures, as well as factory pre-set thermostat cut-in temperatures or thermostats 160 that can change their thermostat cut-in temperatures based on ambient conditions by the means described above.

FIG. 10 shows the electrical connections as the suction temperature safety opens to shut down the gear motor, fan motor and compressor of an exemplary ice making device in accordance with aspects of the present invention. As explained above, this condition occurs when there is an interruption of the water supplied to the evaporator assembly 70. Such an interruption can be caused by dirt or debris in the evaporator assembly 70, for example, or in the water supply hose 65a. It may also be caused by a freeze-up condition in which a portion of the water in the water circuit shown in FIG. 2A freezes severely enough to clog the circuit. Any ice blockage or decrease in the water supplied to the evaporator assembly 70 results in less heat being drawn by the refrigerant in the evaporator assembly 70 and a corresponding drop in the temperature of the refrigerant gas supplied from the evaporator assembly 70 to the compressor 110 by the pipe 120b. This result In t drop in the temperature in the vicinity of the compressor as measured by the suction temperature safety 140 (FIG. 2B). Once the temperature measured by the suction temperature safety 140 reaches a pre-determined suction temperature safety cut-out temperature, the suction temperature safety 140 opens and shuts off power to the compressor 110 and gear motor 80, as shown in FIG. 10.

Even if the suction temperature safety cut-out temperature may not vary with ambient conditions, calibration of the suction temperature safety cut-out temperature may still be necessary. Therefore, variations of this invention include suction temperature safeties 140 with adjustable suction temperature safety cut-out temperatures, and more particularly user adjustable suction temperature safety cut-out temperatures. In additional variations of the present invention, the suction temperature safeties 140, control ice machines 150 or other portions of the ice machine 1000 include systems for measuring ambient temperature and pressure for adjusting the suction temperature safety cut-out temperature accordingly.

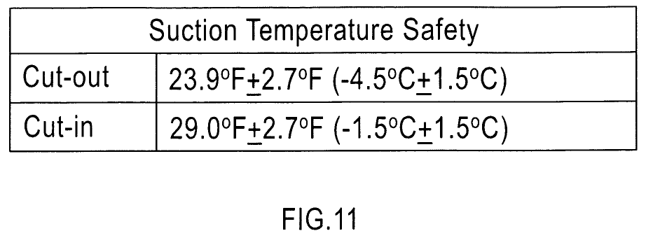

In addition, to the cut-out temperature for the suction temperature safety 140, as described above, there may also be a suction temperature safety cut-in temperature. The suction temperature safety cut-in temperature is the temperature at which the suction temperature safety 140 closes and switches power back on to the compressor 110 and gear motor 80. The suction temperature safety cut-in temperature is the temperature of the second pipe 120b at which freeze-up conditions in the water circuit are no longer problematic, i.e., when all ice blockages have melted. FIG. 11 shows exemplary suction temperature safety cut-out/cut-in temperatures. Variations of the present invention also include thermostats 160 with user-changeable suction temperature safety cut-in temperatures, as well as Factory pre-set suction temperature safety cut-In temperatures or suction temperature safeties 140 that can change their suction temperature safety cut-in temperatures based on ambient conditions by the means described above.

FIG. 9 shows the system 2000 in when the thermostat 160 is open and the suction temperature safety 140 is closed, while FIG. 10 shows the system 2000 when the thermostat 160 is closed and the suction temperature safety 140 is open. It is to be understood, however, that it is possible to have a simultaneously open thermostat 160 and open suction temperature safety 140. This would simply indicate a low water condition in which the bin is full.

The ice making device described herein can be used under a counter or in other confined spaces in domestic and non-domestic and/or professional environments. However, it should be understood that all variations of the present invention can also be used in unconfined spaces and in different environments. Further, although the features of the device might be considered optimal for small-scale provision of ice, it should be appreciated that the design of the device allows it to be scaled for providing ice on a much larger scale.

Example variations and implementations of aspects of the present invention have now been described in accordance with the above advantages. It will be appreciated that these examples are merely illustrative of the present invention. Many variations and modifications will be apparent to those skilled in the art.

In places where the description above refers to particular implementations of electrical output generating devices and/or electrically driven devices, it should be readily apparent that a number of modifications may be made without departing from the spirit thereof and that these aspects, implementations, and variations may be applied to other electrical output generating devices and/or electrically driven devices. The presently disclosed aspects, implementations, and variations are therefore to be considered in all respects as illustrative and not restrictive.

1. An under the counter ice making machine having a top opposite a bottom, a front opposite a back, and left and right opposing sides that collectively define an interior, the ice machine comprising:
a casing defining exterior-most surfaces of the ice machine;
a door positioned on the front of the ice machine and mounted to the casing for providing access to the interior of the ice machine;
an ice bin mounted inside the casing, wherein the ice bin is accessed via the door;
a compressor mounted inside the casing; and
an evaporator assembly disposed inside the casing and above the ice bin, wherein the evaporator assembly manufactures and drives ice toward the ice bin;

2. The ice machine according to claim 1, wherein the evaporator assembly comprises:
a spout;
a cutter; and
a rotatable auger which extrudes ice toward the cutter,
wherein the cutter cuts the ice into at least one of flaked ice and cubed ice and the spout channels the ice into the ice bin.

3. The ice machine according to claim 1, further comprising a gear motor operably connected to and driving an auger included in the evaporator assembly, wherein the gear motor is mounted above the ice bin.

4. The ice machine according to claim 3, wherein the compressor is mounted below the ice bin, wherein the compressor provides a refrigerant to the evaporator assembly to facilitate freezing of water into ice by the evaporator assembly.

5. The ice machine according to claim 4, further comprising:
a water reservoir mounted above the ice bin and in communication with the evaporator assembly, the water reservoir supplying water to the evaporator assembly; and
a float operated water valve for mechanically sensing a level of water in the water reservoir and controlling an amount of water supplied to the water reservoir based on the sensed level of water.

6. The ice machine according to claim 5, further comprising a drain pan channeling water from melted ice in the ice bin away from the ice machine.

7. The ice machine according to claim 1, further comprising a thermostat mounted to a side of the ice bin, the thermostat being in thermal communication with the ice bin to measure a temperature of the ice bin and electrically coupled to the gear motor and the compressor.

8. The ice machine according to claim 7, further comprising a compressor relay electrically coupled to the thermostat for shutting off operation of the compressor according to a first reading taken by the thermostat.

9. The ice machine according to claim 7, further comprising a gear motor protect relay electrically coupled to the thermostat for shutting off operation of the gear motor according to a second reading taken by the thermostat.

10. The ice machine according to claim 3, further comprising a suction line temperature safety provided in the interior of the ice machine and mounted to the back of the ice machine, the suction line temperature safety being electrically coupled to the gear motor and compressor and shutting off operation thereof upon a determination being made that the ice machine is in an ice blockage state.

11. The ice machine according to claim 10, further comprising a compressor relay electrically coupled to the suction line temperature safety for shutting off the operation of the compressor according to a reading taken by the suction line temperature safety.

12. The ice machine according to claim 1, wherein at least one of the evaporator assembly, the gear motor, and the compressor can be serviced without removing the casing.

13. The ice machine according to claim 6, wherein the drain pan can be serviced without removing the casing.
